(19) United States
(12) Patent Application Publication
(10) Pub. No.: US 2007/0142155 A1
(43) Pub. Date: Jun. 21, 2007

(54) Remotely controlled electronically actuated vehicle differential

(75) Inventor: Darren A. Schumacher, Battle Creek, MI (US)

Correspondence Address: JAQUEZ & ASSOCIATES, 6265 Greenwich Drive, Suite 100D, SAN DIEGO, CA, 92122, US

(73) Assignee: DARREN A. SCHUMACHER

(21) Appl. No.: 11/311,020

(22) Filed: Dec. 19, 2005

(51) Int. Cl. F16H 48/30

(52) U.S. Cl. 475/150

(57) ABSTRACT

A remotely controlled electronically actuated vehicle differential system is disclosed. In one embodiment, an electronically actuated vehicle differential is selectively controlled via a remote control unit. The remote control unit generates differential activation and deactivation signals that are received by a wireless receiver unit disposed within a vehicle. An electronically actuated differential is operatively coupled to receive input signals from the wireless receiver unit. The operational status (i.e., engagement or disengagement of a traction modifying differential gear mechanism) of the electronically actuated differential is controlled by the input signals received from the wireless receiver. In one embodiment, the electronically actuated differential comprises an electronically actuated locking differential. In this embodiment, the electronically actuated locking differential fully locks the differential when the locking differential activation signals are received by the wireless receiver unit. The electronically actuated locking differential unlocks the differential when the locking differential deactivation signals are received by the wireless receiver unit.

### CROSS-REFERENCE TO RELATED APPLICATIONS

This application is related to commonly assigned U.S. Pat. No. 6,551,209, entitled “Electronically Actuated Locking Differential”, issued Apr. 22, 2003 to Cheadle, et al. (hereafter the '209 patent), U.S. Pat. No. 6,083,134, entitled “Electronically Actuated Locking Differential”, issued Jul. 4, 2000 to Godlew (hereafter the '134 patent), U.S. Pat. No. 5,911,643, entitled “Differential Gear Mechanism and Improved Ball-ramp Actuation Thereof”, issued Jun. 15, 1999 to Godlew, et al. (hereafter the '643 patent), and commonly-assigned and co-pending application Ser. No. 10/795,651, entitled “Coupling Device and Improved Method of Controlling Torque Transmission” filed Mar. 8, 2004, by Babin, published as application Publication No.: 2005/0194231 (hereafter the “Babin” application). The above-cited '209, '134, and '643 patents, and the Babin application, are incorporated by reference herein in their entirety for their teachings on electronically actuated locking differentials, differential gear mechanisms and limited slip differential mechanisms.

### BACKGROUND

### Field

The present disclosure relates to traction modifying vehicle differentials, and more particularly to remotely controlling electronically actuated vehicle differentials.

Electronic control of various aspects of vehicle systems is becoming increasingly popular. For example, as is well known, vehicle door locks, alarms, windows, suspension systems, brakes, etc., may typically optionally be controlled electronically. For certain vehicle systems it is desirable to provide this electronic control remotely. For example, door locks and car alarms are often remotely controlled using a hand-held remote control device. Also, quite commonly, a “panic” button is provided on a key “FOB” that is used to activate a vehicle alarm. As is well known, a key FOB comprises a small hardware device having built-in authentication mechanisms. Just as keys held on an ordinary key chain or FOB control access to a home or car, the mechanisms in a key FOB may control access to network services and information. As known in the automobile manufacturing and design arts, key FOBs are often used to control access to security and other vehicular functions and systems.

Among the vehicle systems that heretofore have not been remotely controlled is the locking differential. Locking differentials are well-known and have been commonly used in off-road vehicles to vary vehicle traction, especially when driving on rugged terrain. Two such locking differentials are disclosed in the above-incorporated '209 and '134 patents. Traction modifying differentials of the type disclosed in the '209 patent typically include a gear case defining a gear chamber, and disposed therein, a differential gear set including at least one input pinion gear, and a pair of output side gears. A clutch pack is typically disposed between at least one of the side gears and an adjacent surface of the gear case, such that the clutch pack is operable to limit relative rotation between the gear case and the one side gear.

Electronically actuated vehicle differentials may be operated using a variety of operational modes. For example, as described in the '209 patent, the differential may be operated manually, wherein a driver manually selects a locked mode such that the differential operates in the locked mode almost immediately after the vehicle begins to move. Alternatively, the locking differential may be operated in an automatic mode wherein a processing device, for example, a vehicle microprocessor, senses a vehicle operating condition, such as an incipient wheel slip, and transmits an appropriate electrical input signal to the locking differential. In this example, the locking differential responds by locking the side gear relative to a gear case to prevent any further differentiation.

Installation of electronic locking differentials of the type described in the '209 patent typically requires drilling through the vehicle dashboard in order to install a dashboard switch that activates and deactivates the electronically actuated locking differential. Several disadvantages are associated with such an installation process. For example, improper drilling through the dashboard (e.g., drilling from the passenger compartment to the engine compartment) can damage the vehicle dashboard, increase installation costs, and ultimately lead to customer dissatisfaction.

Therefore, a need exists for a remotely activated electronic locking differential that addresses the disadvantages of the prior art locking differentials. The present disclosure provides a solution that overcomes the disadvantages associated with prior art approaches.

### SUMMARY

A remotely controlled electronically actuated differential system adapted to toggle actuation of a traction modifying differential in a vehicle is disclosed. The remotely controlled vehicle differential system comprises, a control unit generating first and second control signals, wherein the first control signal controls engagement of the traction modifying differential, and wherein the second control signal controls disengagement of the traction modifying differential. The remotely controlled vehicle differential system further comprises a transmitter wirelessly transmitting the first and second control signals, a receiver, disposed within the vehicle, adapted to receive the first and second control signals, and an electronically actuated differential mechanism, operatively coupled to the receiver, wherein the differential mechanism engages the traction modifying differential when the first control signal is received by the receiver, and wherein the differential mechanism disengages the traction modifying differential when the second control signal is received by the receiver.

A remotely controlled electronically actuated vehicle differential system is disclosed. In one embodiment, the remotely controlled electronically actuated vehicle differential system selectively locks and unlocks an electronically actuated locking differential disposed within a vehicle. In one embodiment, the remotely controlled electronically actuated differential system comprises a remote control unit, a wireless receiver unit disposed within the vehicle, and an electronically actuated locking differential. Responsive to user input and control, the remote control unit transmits locking differential activation and deactivation signals to the wireless receiver unit via a wireless communication link. The wireless receiver unit is electrically coupled to the electronically actuated locking differential via an electrical link. Responsive to the activation and deactivation signals received from the remote control unit, the wireless receiver unit transmits actuation and de-actuation electrical input signals to the electronically actuated locking differential that fully locks and unlocks, respectively, the vehicle differential gearing. The electronically actuated locking differential is fully locked when the activation signal is transmitted by the remote control unit, and unlocked when the deactivation signal is transmitted.

### BRIEF DESCRIPTION OF THE DRAWINGS

Embodiments of the present disclosure are more readily understood by reference to the following figures, in which like reference numbers and designations indicate like elements.

FIG. 1 is a simplified block diagram of a remotely controlled electronically actuated vehicle differential system made in accordance with the present teachings.

FIG. 2 is a schematic diagram showing details of one embodiment of the remotely controlled electronically actuated vehicle differential system of FIG. 1.

FIG. 3 is a schematic diagram of one embodiment of a wireless receiver adapted for use in the remotely controlled electronically actuated vehicle differential systems of FIGS. 1 and 2.

FIG. 4 is a schematic diagram of one embodiment of a remotely controlled variable torque vehicle differential system made in accordance with the present teachings.

FIG. 5 is a simplified block diagram of another embodiment of a remotely controlled electronically actuated vehicle differential system made in accordance with the present teachings.

### DETAILED DESCRIPTION

The present teachings disclose an improved system and apparatus for controlling an electronically actuated locking differential.

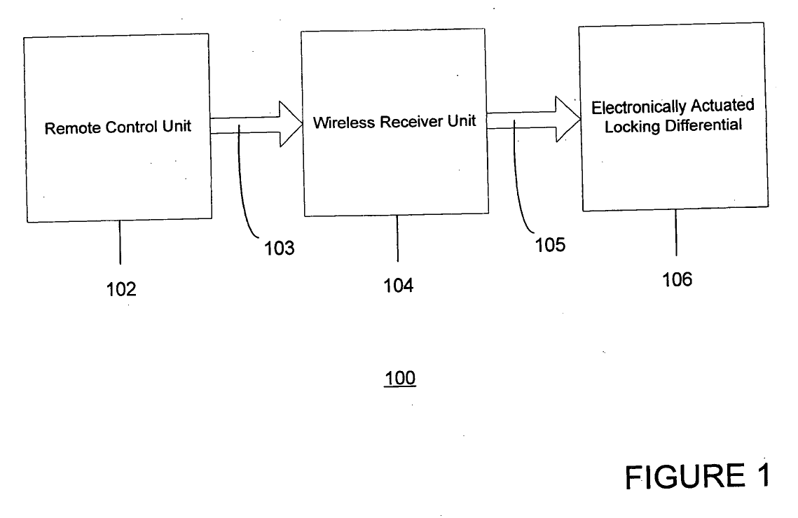

FIG. 1 is a simplified block diagram of an exemplary embodiment of a remotely controlled electronically actuated vehicle differential system 100 made in accordance with the present teachings. As shown in FIG. 1, in one embodiment, the remotely controlled electronically actuated vehicle differential system 100 comprises a remote control unit 102, a wireless receiver unit 104, and an electronically actuated locking differential 106. The remote control unit 102 communicates with the wireless receiver unit 104 via a wireless communication link 103. The wireless communication link 103 may comprise any convenient well known wireless communication link, such as, for example, a radio frequency (“RF”) wireless communication link. Exemplary wireless communication links include those conforming to the well known “Bluetooth™” protocols that facilitate the transport of data between Bluetooth™ devices such as wireless headsets, cellular phones and personal digital assistants (PDAs). As is well known, the Bluetooth™ protocol is a global specification standard for radio communications operating at 2.4 GHz radio frequencies. However, radio frequency wireless links are exemplary only, and those skilled in the electronic design and manufacture arts shall appreciate that any convenient wireless link can be used to practice the present teachings.

As described in more detail below, responsive to input from a vehicle user (typically the driver), not shown, the remote control unit 102 transmits locking differential activation and deactivation signals to the wireless receiver unit 104 via the wireless communication link 103. As shown in FIG. 1, the wireless receiver unit 104 is in electrical communication with the electronically actuated locking differential 106 via an electrical link 105. The wireless receiver unit 104 receives the locking differential activation and deactivation signals from the remote control unit 102, and, responsive to these signals, activates and deactivates the electronically actuated locking differential 106 by transmitting the appropriate electrical input signals via the electrical link 105.

In one exemplary embodiment, the electronically actuated locking differential 106 is implemented according to the teachings of the commonly assigned '209 patent. As described in more detail in the '209 patent, the electronically actuated locking differential 106 may be selectively actuated in response to an externally applied electrical input signal. The electrical input signal is applied to an electromagnetic actuator (e.g., an electromagnetic coil) disposed within the locking differential. When the electrical signal is applied (i.e., when the electrical signal corresponds to an “energized” condition) thereby energizing the electromagnetic actuator, the differential operates in an actuated “locked differential” operating mode. When the electrical signal is not applied (i.e., when the electrical signal corresponds to a “de-energized” condition) to the electromagnetic actuator and the actuator is thereby de-energized, the locking differential operates in an unactuated “open differential” operating mode.

As described in more detail in the '209 patent, the electronically actuated locking differential may be controlled either manually or automatically. When manually controlled, the driver (or other vehicle occupant) manually selects a locked operating mode when desired. The driver controls the electronically actuated locking differential by throwing a manual switch (or pushbutton), typically disposed on the vehicle dashboard, which, in turn, controls the locking differential. When automatically controlled, a vehicle microprocessor, or some other computing device located within the vehicle, senses the vehicle operating conditions and transmits appropriate electrical input signals to the electromagnetic actuator which either locks or unlocks the electronically actuated locking differential. In other embodiments, the electronically actuated differential 106 comprises a vehicle differential whose operational status (i.e., engagement or disengagement of a traction modifying differential gear mechanism) is controlled in response to electrical input signals.

Referring again to FIG. 1, instead of using a manual switch or pushbutton that activates/de-activates the locking differential 106, the driver uses the remote control unit 102. In accordance with the present teachings, the driver or other occupant selects the desired differential operating mode (locked or unlocked) by appropriately controlling the remote control unit 102. The remote control unit 102 communicates with the wireless receiver unit 104 via the communication link 103, and the appropriate actuation/de-actuation electrical input signal is applied (via the link 105) to the electronically actuated locking differential 106.

As described above in the Background section, use of a remote control unit, such as the remote control unit 102 of FIG. 1, to remotely control the electronically actuated locking differential 106 greatly simplifies installation of the locking differential. This is especially true when the locking differential is installed “after market” (i.e., when installed after the vehicle is purchased from the manufacturer). Using the remotely controlled electronically actuated differential system 100 of the present disclosure, no drilling or other alteration of the vehicle interior is necessary. Rather, owing to the wireless communication link 103 between the remote control unit 102 and the wireless receiver unit 104, the electronically actuated locking differential 106 may be controlled by a user without installation of a manual switch or push button within the vehicle interior. As described above, this eliminates the potential damage to the vehicle interior associated with prior art installations. In addition, it greatly reduces installation costs and complexity as compared with the prior art approaches.

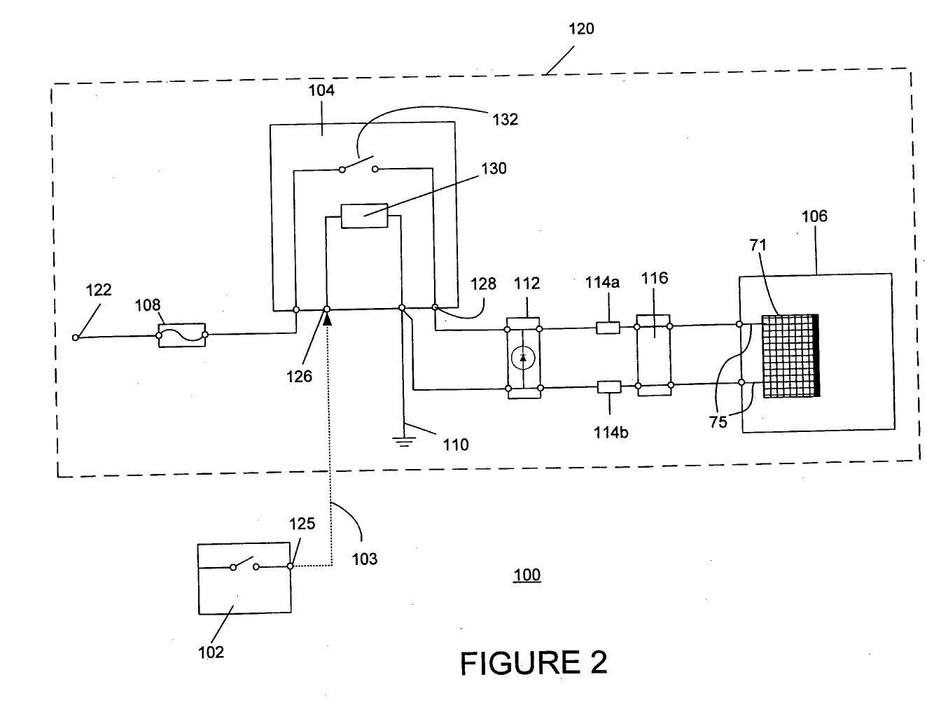

FIG. 2 is a schematic diagram showing details of one embodiment of the remotely controlled electronically actuated vehicle differential system 100 of FIG. 1. As shown in FIG. 2, the vehicle differential system 100 includes the remote control unit 102 and an electronically actuated differential mechanism 120 including, inter alia, a wireless receiver unit 104 and an electronically actuated locking differential 106 operatively coupled thereto through a series of electrical sub-components. The remote control unit 102 is wirelessly coupled to the wireless receiver unit 104 via a wireless communications link 103. As described above with reference to FIG. 1, the remote control unit 102 transmits locking differential activation and deactivation signals to the wireless receiver unit 104 via the wireless communication link 103. Responsive to the activation/deactivation signals received from the remote control unit 102, the wireless receiver unit 104 outputs appropriate actuation/de-actuation electrical input signals and these signals are applied to the electronically actuated locking differential 106 through a series of electrical sub-components (i.e., sub-components 112, 114 and 116 described in more detail below).

As described in the above-incorporated '209 patent, the electronically actuated locking differential 106 includes an actuation mechanism that functions to lock and unlock the differential based upon electrical input signals applied thereto. As shown in FIG. 2, the exemplary embodiment of the electronically actuated locking differential 106 includes an electromagnetic coil 71 that is analogous in design and function to the electromagnetic coil described in the '209 patent (see, e.g., FIG. 2 of the '209 patent and the accompanying description). The electromagnetic coil 71 is adapted to receive electrical input signals by means of electrical leads 75 shown schematically in FIG. 2. As described in the '209 patent, in one embodiment, the electromagnetic coil 71 may be made in accordance with the teachings of the above-incorporated '643 patent. In the exemplary embodiment, the actuation/de-actuation electrical input signals output by the wireless receiver unit 104 are applied to the electromagnetic coil 71 via the electrical leads 75. The electromagnetic coil 71 is energized when the actuation electrical input signal is applied to the electrical leads 75, and de-energized when the de-actuation signal is applied thereto. As described in more detail the '209 patent, the locking differential is locked when the electromagnetic coil 71 is energized, and unlocked when it is de-energized.

As described above with reference to the system 100 of FIG. 1, the wireless communication link 103 may be implemented using any convenient wireless communication technology. For example, in addition to being implemented as an RF wireless communication link, those skilled in the wireless arts shall appreciate that the link 103 may be implemented as a microwave or optical communication link. In addition, in order to avoid inadvertent or accidental activation/deactivation of the locking differential 106, a wide variety of modulation/demodulation and data encryption schemes may be used in implementing the wireless communication link 103. These schemes can also serve to enhance the security of the wireless communications link 103. These modulation/demodulation schemes include but are not limited to frequency modulation (FM), amplitude modulation (AM), phase modulation (PM), pulse code modulation (PCM, quadrature phase shift key (QPSK), quadrature amplitude modulation (QAM), orthogonal frequency division multiplexing (OFDM), and any other modulation format adaptable for use with the system 100 shown in FIGS. 1 and 2.

Referring again to the differential system 100 of FIG. 2, in the exemplary embodiment, the electronically actuated differential mechanism 120 may include several sub-components, including a fuse 108, the wireless receiver unit 104, an electronic suppression device 112, a pair of butt joints 114a, 114b, an electrical connector 116 (having male and female connectors on opposite sides), and the locking differential 106.

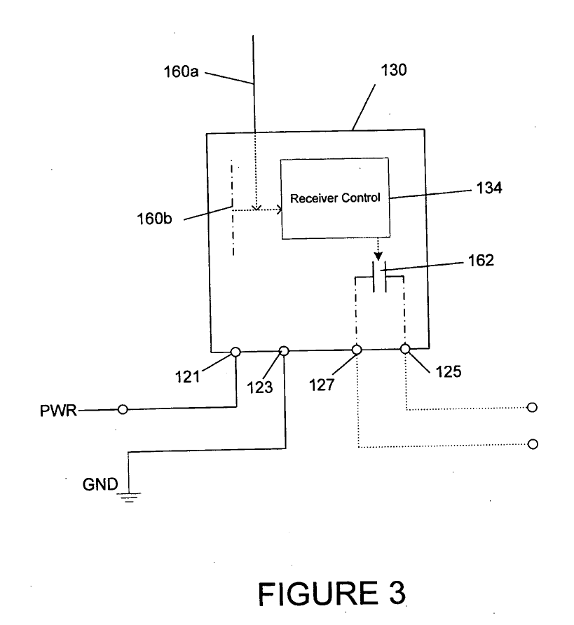

In the embodiment shown in FIG. 2, the wireless receiver unit 104 includes a wireless receiver 130 and a relay device 132. The wireless receiver 130 receives information transmitted over the wireless communication link 103 at a wireless link input port 126. Implementation of the link input port 126 varies depending upon the wireless technology used in implementing the wireless link 103 (for example, the input port 126 may comprise an RF antenna as described below in more detail with reference to FIG. 3, an optical link input port, etc.). As shown in FIG. 2, a first terminal of the relay device 132 is coupled through the fuse 108 to an input voltage (not shown) that is applied to an input voltage port 122. A second terminal of the relay device 132 is coupled to an output port 128 of the wireless receiver unit 104. In the exemplary embodiment, the output port 128 is coupled (via a series of electrical sub-components 112, 114 and 116) to the electrical leads 75 of the electromagnetic coil 71 disposed within the locking differential 106.

When the relay device 132 is closed, the input voltage that is applied to the input voltage port 122 is applied to the output port 128 and to the electromagnetic coil 71. When the relay device 132 is open, the input voltage is disconnected from the output port 128, and no signal is applied to the electromagnetic coil 71 of the locking differential 106. As shall be appreciated by those skilled in the electronic device design and manufacturing arts, in other embodiments, the switching function of the relay device 132 may be implemented using a solid state switch, integrated circuit (IC), or other well known switch device.

The wireless receiver 130 controls operation of the relay device 132 (i.e., controls the opening and closing of the relay 132) responsive to the signals received at the input port 126. More specifically, the wireless receiver 130 receives the locking differential activation/deactivation signals output by the remote control unit 102 in response to user input, and appropriately closes and opens the relay device 132 responsive to these signals. The closing and opening of the relay 132 applies and disconnects, respectively, the input voltage (applied at the input voltage port 122) to the output port 128. In this manner, the wireless receiver unit 104 applies the actuation/de-actuation electrical input signals to the electronically actuated locking differential 106 (and more specifically, to the electromagnetic coil 71 of the locking differential 106) via the electrical sub-components 112, 114 and 116.

In the embodiment illustrated in FIG. 2, the wireless receiver 130 is housed within the same housing as the relay device 132. However, those skilled in the electronic design and manufacturing arts shall appreciate that the wireless receiver 130 does not need to be housed within the same housing as the relay device 132 in order to practice the disclosed apparatus. As shown in FIG. 2, the electronically actuated differential mechanism 120 also optionally includes a suppression device 112 that electronically couples the relay 132 to the butt joints 114a, 114b. The electrical connector 116 couples the butt joints 114a, 114b to the electrical leads 75 of the electromagnetic coil 71 disposed within the locking differential 106. As described above in more detail, although many locking differentials are known in the prior art, in one exemplary embodiment, the locking differential 106 is implemented in accordance with the teachings of the commonly assigned '209 patent. As described above, in other embodiments, the electronically actuated locking differential 106 is implemented using any convenient vehicle differential whose operational status is controlled in response to electrical input signals.

In one embodiment, the remote control unit 102 includes a switching mechanism and a wireless transmitter that is adapted to transmit locking differential activation and deactivation signals responsive to the state of the switching mechanism. Examples of switching mechanisms that can be used in the implementation of the remote control unit include push-button switches, toggle switches, capacitive type switches (responsive to variations in electrical fields caused by user movement), and any type of switch that creates an electrical connection between electronic components responsive to user input.

In one embodiment, the remote control unit 102 is implemented as an “in-dash” wireless switch. In this embodiment, the remote control unit 102 is mounted to the vehicle dashboard. It will be appreciated by those skilled in the vehicle design and manufacturing arts that the disclosed “in-dash” implementation overcomes the aforementioned disadvantages of the prior art approaches because holes need not be drilled between the passenger compartment and the engine compartment using the disclosed remote control unit.

FIG. 3 is a schematic diagram showing details of one embodiment of a wireless receiver 130 adapted for use with the remotely controlled electronically actuated vehicle differential systems 100 of FIGS. 1 and 2. In the illustrated embodiment, the wireless receiver 130 includes an antenna 160 and a receiver control block 134. As shown in FIG. 3, in some embodiments the antenna 160 comprises an external antenna 160a (i.e., external to the wireless receiver 130), and in other embodiments the antenna 160 comprises an internal antenna 160b. In the exemplary embodiment, the antenna 160 comprises an RF antenna capable of receiving RF signals transmitted by the remote control unit 102. In the embodiment 130 shown in FIG. 3, the antenna 160 corresponds to the wireless link input port 126 described above with reference to FIG. 2.

In the exemplary embodiment shown in FIG. 3, the wireless receiver 130 also includes a relay capacitor 162. The relay capacitor is coupled to the relay device 132 described above with reference to FIG. 2. In one embodiment, the relay capacitor 162 is coupled to contacts of the relay device 132 at electrical connection points 125, 127. As described above with reference to FIG. 2, the receiver control 134 controls operation of the relay device 132 responsive to the activation and deactivation signals received from the remote control unit 102.

The wireless receiver 130 may be powered independently (for example, powered by an internal power supply such as a battery), or it may derive power from the vehicle electrical power system. For example, as shown in FIG. 3, power may be provided to the receiver 130 via power supply input connections 121 and 123. In one embodiment, the power supply input connection 121 is connected to a +12V ignition power supply source, and the connection 123 is coupled to a vehicle ground. Those skilled in the electronics design and manufacturing arts shall understand that alternative techniques for powering the wireless receiver 130 may be used without departing from the scope or spirit of the disclosed remotely controlled electronically actuated vehicle differential system.

In one embodiment, the remote control unit 102 is mounted within a key FOB device. As described above, key FOB devices are well known in the automobile design and manufacturing arts. Key FOB devices are widely used in the automobile industry to remotely control a variety of vehicle systems. For example, FOB devices have been used to remotely control the locking and unlocking or vehicle doors, setting of vehicle alarms, providing “panic” functions, and opening and closing vehicle trunks. In addition to being implemented within a key FOB device, the remote control unit 102 may also be implemented within a remote control device such as a garage door opener. As will be appreciated by those skilled in the electronics design and manufacturing arts, the remote control unit 102 may be mounted within literally any type of remote control hand-held device.

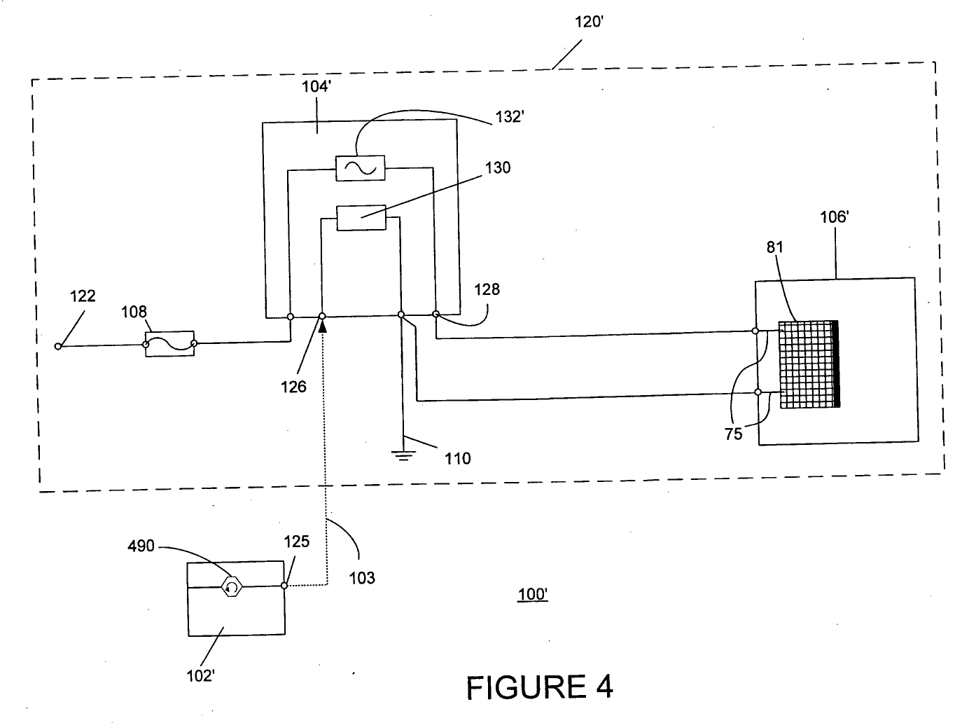

Referring again to FIG. 2, in yet another exemplary embodiment, the electronically actuated vehicle differential 106 may be implemented in accordance with the teachings set forth in the above-incorporated Babin application. In accordance with this embodiment, as described below in more detail, the electronically actuated vehicle differential 106 is similar in design to the “coupling device” described in the incorporated Babin application. As described in more detail in the Babin application, the term “coupling device” includes a device that is capable of transmitting torque from an input to one or more outputs, and within which there is a clutch assembly disposed between the input and the output, such that the amount of torque transmitted is a function of the extent of engagement of the clutch assembly. FIG. 4 shows a simplified block diagram of such an exemplary embodiment. More specifically, FIG. 4 shows details of one embodiment of a remotely controlled variable torque vehicle differential system 100′ made in accordance with the present teachings.

As shown in FIG. 4, the remotely controlled variable torque vehicle differential system 100′ includes a remote control unit 102′ and a variable torque vehicle differential mechanism 120′ including, a wireless receiver unit 104′ and an electronically actuated variable torque vehicle differential 106′ coupled thereto. Similar to the system 100 described above with reference to FIGS. 1 and 2, the remote control unit 102′ is wirelessly coupled to the wireless receiver unit 104′ via a wireless communications link 103. As described above, the remote control unit 102′ transmits differential control signals to the wireless receiver unit 104′ via the wireless communication link 103.

As shown in FIG. 4, the remote control unit 102′ includes an input device 490. In some embodiments, the input device 490 comprises a knob, slider, wheel, or other similar input device capable of generating a plurality of differential control signals. The differential control signals are wirelessly transmitted to the wireless receiver unit 104′. As described below in more detail, by manipulating the input device 490, a user (typically the vehicle driver) may remotely control coupling torque transmission (from minimum to maximum torque transmission) applied by the electronically actuated variable torque vehicle differential 106′.

The wireless receiver unit 104′ includes the wireless receiver 130 and a variable switching device 132′. The wireless receiver 130 receives the plurality of differential control signals transmitted by the remote control unit 102′ via the wireless communication link 103 at a wireless link input port 126. As shall be appreciated by those skilled in the electronic design and manufacturing arts, the variable switching device 132′ may be implemented as a solid state switch, integrated circuit (IC), or other well known switching device. Responsive to the differential control signals transmitted via the wireless link 103, the wireless receiver 130 controls operation of the variable switching device 132′. More specifically, the wireless receiver 130 receives the control signals output by the remote control unit 102′, and varies the current generated by the variable switching device 132′ responsive to the control signals. A first terminal of the switching device 132′ is coupled through the fuse 108 to an input voltage (not shown) applied to the input voltage port 122. A second terminal of the switching device 132′ is coupled to the output port 128 of the wireless receiver unit 104′.

In the exemplary embodiment, the output port 128 is coupled to the electrical leads 75 of an electromagnetic coil 81 disposed within the electronically actuated variable torque vehicle differential 106′. The current output by the switching device 132′ (responsive to remotely generated differential control signals as described above) is therefore applied to the electromagnetic coil 81, and thereby controls the coupling torque generated by the variable torque vehicle differential 106′.

As briefly noted above, in the exemplary embodiment shown in FIG. 4, the electronically actuated variable torque vehicle differential 106′ is implemented in accordance with the teachings of the Babin application. As noted above, Babin discloses a coupling device, such as a limited slip differential, in which there is a clutch pack that is variable between disengaged, partially engaged, and fully engaged conditions. As described in more detail in the Babin application, clutch pack torque transmission is determined by hydraulic pressure on a clutch piston. The hydraulic pressure in the clutch piston chamber is controlled by pressure control solenoid valve. The clutch pack can be totally disengaged (zero torque transmission), partially engaged (partial torque transmission) or fully engaged (fully locked). Coupling torque transmission is ultimately determined and controlled by the magnitude of current that is applied to the electromagnetic coil 81. Zero coil current corresponds to a minimum clutch apply pressure (i.e., the differential is disengaged and zero torque transmission is generated by the differential 106′). Increasing applied current to the coil 81 creates a corresponding increase in clutch torque transmission generated by the differential 106′. When a maximum current is applied to the electromagnetic coil 81, the differential is fully engaged. In summary, in accordance with the exemplary embodiment shown in FIG. 4, the user remotely controls the current that is applied to the electromagnetic coil 81, and therefore remotely controls the coupling torque transmission generated by the differential 106′.

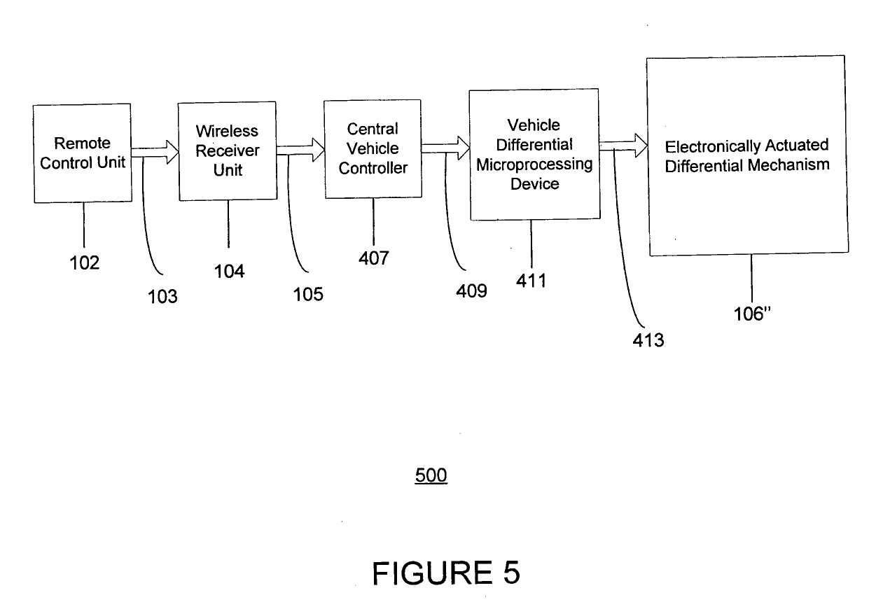

FIG. 5 is a simplified block diagram of an exemplary embodiment of a remotely controlled electronically actuated vehicle differential system 500 made in accordance with the present teachings. As shown in FIG. 5, in one embodiment, the remotely controlled electronically actuated vehicle differential system 500 comprises the remote control unit 102, the wireless receiver unit 104, a central vehicle controller 407, a vehicle differential microprocessing device 411, and an electronically actuated differential mechanism 106″. As described above with reference to the system of FIG. 1, the remote control unit 102 communicates with the wireless receiver unit 104 via a wireless communication link 103. Responsive to input from a vehicle user, the remote control unit 102 transmits a plurality of differential activation and deactivation signals to the wireless receiver unit 104 via the wireless communication link 103.

The wireless receiver unit 104 communicates with a central vehicle controller 407 via a communication link 105. Responsive to the differential activation and deactivation signals received from the remote control unit 102, the wireless receiver unit 104 outputs a plurality of differential control signals. The plurality of differential control signals is transmitted to the central vehicle controller 407 via the communication link 105. The central vehicle controller 407 controls operation of a plurality of vehicle systems, including, but not limited to, the electronically actuated differential mechanism 106″.

The vehicle differential microprocessing device 411 receives the plurality of differential control signals from the central vehicle controller 407 via a communication bus 409. Responsive to the differential control signals received from the central vehicle controller 407, the vehicle differential microprocessing device 411 controls activation and deactivation of the electronically actuated differential mechanism 106″. The electronically actuated differential mechanism 106″ controls engagement and disengagement of the vehicle differential based upon the control signals received from the vehicle differential microprocessing device 411.

The foregoing description illustrates exemplary implementations, and novel features, of aspects of a remotely controlled electronically actuated locking differential. Alternative implementations are suggested, but it is impractical to list all alternative implementations of the remotely controlled electronically actuated locking differential. Therefore, the scope of the presented disclosure should be determined only by reference to the appended claims, and should not be limited by features illustrated in the foregoing description except insofar as such limitation is recited in an appended claim.

While the above description has pointed out novel features of the present disclosure as applied to various embodiments, the skilled person will understand that various omissions, substitutions, permutations, and changes in the form and details of the systems illustrated may be made without departing from the scope of the present teachings.

Each practical and novel combination of the elements and alternatives described hereinabove, and each practical combination of equivalents to such elements, is contemplated as an embodiment of the present teachings. Because many more element combinations are contemplated as embodiments of the present teachings than can reasonably be explicitly enumerated herein, the scope of the present teachings is properly defined by the appended claims rather than by the foregoing description. All variations coming within the meaning and range of equivalency of the various claim elements are embraced within the scope of the corresponding claim. Each claim set forth below is intended to encompass any apparatus that differs only insubstantially from the literal language of such claim, as long as such apparatus is not, in fact, an embodiment of the prior art. To this end, each described element in each claim should be construed as broadly as possible, and moreover should be understood to encompass any equivalent to such element insofar as possible without also encompassing the prior art. Furthermore, to the extent that the term “includes” is used in either the detailed description or the claims, such term is intended to be inclusive in a manner similar to the term “comprising.”

What is claimed is:

1. A remotely controlled electronically actuated vehicle differential system, the vehicle differential system selectively locking and unlocking a vehicle differential, comprising:
(a) a remote control unit generating locking differential activation and deactivation signals responsive to control by a user;
(b) a wireless receiver unit disposed within the vehicle, wherein the wireless receiver unit is adapted to receive the locking differential activation and deactivation signals from the remote control unit; and
(c) an electronically actuated locking differential, operatively coupled to the wireless receiver unit, wherein the locking differential fully locks when the locking differential activation signal is received by the wireless receiver unit, and wherein the locking differential unlocks when the locking differential deactivation signal is received by the wireless receiver unit

2. The remotely controlled electronically actuated vehicle differential system of claim 1, wherein the remote control unit communicates with the wireless receiver unit via a wireless communication link.

3. The remotely controlled electronically actuated locking differential system of claim 2, wherein the wireless communication link comprises a radio frequency (RF) link.

4. The remotely controlled electronically actuated vehicle differential system of claim 2, wherein the wireless communication link comprises an optical data communication link.

5. The remotely controlled electronically actuated vehicle differential system of claim 2, wherein the wireless communication link comprises an acoustical data link.

6. The remotely controlled electronically actuated vehicle differential system of claim 1, wherein the remote control unit is disposed within an interior compartment of the vehicle.

7. The remotely controlled electronically actuated vehicle differential system of claim 1, wherein the remote control unit is disposed within a key FOB.

8. The remotely controlled electronically actuated vehicle differential system of claim 1, wherein the wireless receiver unit comprises a wireless receiver and a relay device, and wherein the wireless receiver receives the locking differential activation and deactivation signals from the remote control unit and controls operation of the relay device responsive to the received activation and deactivation signals thereby applying actuation and de-actuation electrical input signals to the electronically actuated locking differential.

9. The remotely controlled electronically actuated vehicle differential system of claim 8, wherein the electronically actuated locking differential includes an electromagnetic coil adapted to receive the actuation and de-actuation electrical input signals, and wherein the electromagnetic coil is energized when the actuation input signal is applied and de-energized when the de-actuation input signal is applied, and wherein the locking differential fully locks when the electromagnetic coil is energized and unlocks when the electromagnetic coil is de-energized.

10. The remotely controlled electronically actuated vehicle differential system of claim 8, wherein the wireless receiver comprises an antenna and a receiver control block, and wherein the antenna is adapted to receive the locking differential activation and deactivation signals from the remote control unit, and wherein the receiver control block controls operation of the relay device responsive to the received activation and deactivation signals.

11. The remotely controlled electronically actuated vehicle differential system of claim 10, wherein the remote control unit communicates with the wireless receiver unit via a radio frequency (RF) link, and wherein the antenna comprises an RF antenna.

12. A remotely controlled electronically actuated vehicle differential system, the vehicle differential system selectively locking and unlocking a vehicle differential, comprising:
(a) means for remotely generating locking differential activation and deactivation signals;
(b) means, responsive to the signal generating means, for receiving the locking differential activation and deactivation signals, wherein the activation and deactivation signals are transmitted from the signal generating means to the signal receiving means via a wireless communication link; and
(c) means, responsive to the signal receiving means, for locking and unlocking the vehicle differential, wherein the differential locking and unlocking means locks the vehicle differential when the locking differential activation signal is received by the signal receiving means, and wherein the differential locking and unlocking means unlocks the vehicle differential when the locking differential deactivation signal is received by the signal receiving means.

13. A remotely controlled differential locking system adapted to toggle actuation of a traction modifying locking differential in a vehicle, comprising:
(a) a control unit generating first and second control signals, wherein the first control signal controls engagement of the traction modifying locking differential, and wherein the second control signal controls disengagement of the traction modifying locking differential;
(b) a transmitter wirelessly transmitting the first and second control signals;
(c) a receiver, disposed within the vehicle, adapted to receive the first and second control signals; and
(d) an electronically actuated locking differential mechanism, operatively coupled to the receiver, wherein the locking differential mechanism engages the traction modifying locking differential when the first control signal is received by the receiver, and wherein the locking differential mechanism disengages the traction modifying locking differential when the second control signal is received by the receiver.

14. The remotely controlled differential locking system of claim 13, wherein the control unit comprises a hand-held wireless remote control device.

15. The remotely controlled differential locking system of claim 13, wherein the control unit comprises a wireless remote control device installed in an interior occupant compartment of the vehicle.

16. The remotely controlled differential locking system of claim 14, wherein the hand-held wireless remote control device comprises a key FOB.

17. The remotely controlled differential locking system of claim 13, wherein the first control signal comprises a locking differential activation signal, and wherein the second control signal comprises a locking differential deactivation signal.

18. The remotely controlled differential locking system of claim 15, wherein the remote control device includes a switching mechanism, and wherein a vehicle occupant controls engagement and disengagement of the traction modifying locking differential using the switching mechanism.

19. The remotely controlled differential locking system of claim 18, wherein the switching mechanism comprises a push-button switch.

20. The remotely controlled differential locking system of claim 18, wherein the switching mechanism comprises a toggle switch.

21. The remotely controlled differential locking system of claim 18, wherein the switching mechanism comprises a capacitive switch.

22. The remotely controlled differential locking system of claim 17, wherein the locking differential mechanism includes an electromagnetic coil, and wherein the electromagnetic coil is energized when the locking differential activation signal is received by the receiver, and wherein the electromagnetic coil is de-energized when the locking differential deactivation signal is received by the receiver, and wherein the locking differential mechanism engages the traction modifying locking differential when the electromagnetic coil is energized and disengages the traction modifying locking differential when the electromagnetic coil is de-energized.

23. A remotely controlled vehicle differential system adapted to toggle actuation of a traction modifying differential in a vehicle, comprising:
(a) a control unit generating first and second control signals, wherein the first control signal controls engagement of the traction modifying differential, and wherein the second control signal controls disengagement of the traction modifying differential;
(b) a transmitter wirelessly transmitting the first and second control signals;
(c) a receiver, disposed within the vehicle, adapted to receive the first and second control signals; and
(d) an electronically actuated differential mechanism, operatively coupled to the receiver, wherein the differential mechanism engages the traction modifying differential when the first control signal is received by the receiver, and wherein the differential mechanism disengages the traction modifying differential when the second control signal is received by the receiver.

24. A remotely controlled variable torque vehicle differential system adapted to control actuation of a traction modifying differential in a vehicle, comprising:
(a) a control unit generating a plurality of differential control signals wherein the control signals responsive to user input;
(b) a transmitter wirelessly transmitting the plurality of control signals;
(c) a receiver, disposed within the vehicle, adapted to receive the plurality of control signals; and
(d) an electronically actuated variable torque vehicle differential mechanism, wherein the variable torque differential mechanism transmits a variable coupling torque responsive to the plurality of control signals.

25. The remotely controlled variable torque vehicle differential system of claim 24, wherein the electronically actuated variable torque vehicle differential mechanism includes a clutch pack and an electromagnetic coil disposed therein, and wherein the coupling torque transmitted by the electronically actuated variable torque vehicle differential mechanism is determined by current applied to the electromagnetic coil.

26. A remotely controlled vehicle differential system, adapted to control actuation of a traction modifying differential in a vehicle, comprising:
(a) a control unit generating a plurality of control signals responsive to user input, wherein the plurality of control signals controls actuation of the traction modifying differential from zero engagement to full engagement;
(b) a transmitter, coupled to the control unit, wirelessly transmitting a plurality of differential activation and deactivation signals responsive to the plurality of control signals;
(c) a receiver, disposed within the vehicle, adapted to receive the differential activation and deactivation signals, wherein the receiver outputs a plurality of differential control signals responsive to the differential activation and deactivation signals;
(d) a central vehicle controller configured to control a plurality of vehicle systems and operatively coupled to the receiver, wherein the central vehicle controller is adapted to receive the differential control signals;
(e) a vehicle differential microprocessor in communication with the central vehicle controller via a communications bus; and
(f) an electronically actuated variable torque vehicle differential mechanism in operative communication with the vehicle differential microprocessor, wherein the variable torque differential mechanism transmits a variable coupling torque responsive to control signals output by the vehicle differential microprocessor.
